(19) United States
(12) Patent Application Publication
(10) Pub. No.: US 2023/0189690 A1
(43) Pub. Date: Jun. 22, 2023

(54) DATA VISUALIZATION AND ANALYSIS FOR HARVEST STAND COUNTER AND RELATED SYSTEMS AND METHODS

(71) Applicant: Ag Leader Technology, Ames, IA (US)

(72) Inventors: Aaron Friedlein, Farmersburg, IA (US); Joe Holoubek, Ames, IA (US); Corey Weddle, Ames, IA (US); David Wilson, Prairie City, IA (US)

(21) Appl. No.: 18/087,413

(22) Filed: Dec. 22, 2022

Related U.S. Application Data
(60) Provisional application No. 63/292,796, filed on Dec. 22, 2021.

(51) Int. Cl. A01B 79/00; A01D 41/127; A01D 45/02

(52) U.S. Cl. CPC A01B 79/005; A01D 41/1271; A01D 41/1278; A01D 45/021

(57) ABSTRACT

An agricultural data system comprising at least one stalk sensor disposed on a harvester configured to sense incoming crop stalks, at least one processor in communication with the at least one stalk sensor, and a display in communication with the at least one processor, wherein the processor is configured to align as-planted data with as-harvested data from the at least one stalk sensor.

### CROSS REFERENCE TO RELATED APPLICATION

This application claims the benefit under 35 U.S.C. § 119(e) to U.S. Provisional Application 63/292,796, filed Dec. 22, 2021, and entitled Data Visualization and Analysis for Harvest Stand Counter, which is hereby incorporated herein by reference in its entirety for all purposes.

### TECHNICAL FIELD

The disclosure relates to agricultural sensors and systems for counting, quantifying, and visualizing harvest data.

### BACKGROUND

Various sensors for measuring and counting stalks and collecting certain data relating to harvest and planting are known in the art. Various sensors are disclosed in U.S. application Ser. No. 16/445,161, U.S. application Ser. No. 16/800,469, U.S. application Ser. No. 17/013,037, and U.S. application Ser. No. 17/226,002, each of which has been incorporated by reference herein.

### BRIEF SUMMARY

Disclosed herein are various methods and related systems and devices for generating and displaying various information, such as harvest data, to a user in real-time, as well as, logging various data for future analysis.

Various implementations relate to row-by-row harvest estimation, including the determination of row-by-row yield estimates. Various implementations relate to a system for collecting and displaying information to a user or operator, certain examples being harvest stand efficiency, harvest difference, graphical representations of stock stand trends and/or anomalies, field trial information where harvest stand is used as a metric, and the like. Further implementations incorporate additional features for display to a user and/or adjustment of various harvesting systems, such as the use of heading and/or turning rate information and compensation/adjustments, adjusting a counting algorithm and analysis methods based on field and crop conditions, providing guess row warnings, providing desktop and/or cloud reports to users, providing a planter report card, improving data accuracy, and the like. Further implementations will be apparent to those of skill in the art from the disclosure contained herein.

Example 1 relates to an agricultural data system comprising at least one stalk sensor disposed on a harvester configured to sense incoming crop stalks, at least one processor in communication with the at least one stalk sensor, and a display in communication with the at least one processor, wherein the processor is configured to align as-planted data with as-harvested data from the at least one stalk sensor.

In Example 2, the system of Example 1, further comprising at least one GNSS unit in communication with the at least one processor.

In Example 3, the system of Example 1, wherein the at least one processor is configured to detect when the harvester has harvested crop at an offset.

In Example 4, the system of Example 1, wherein the at least one processor is configured to map, chart, or report one or more of: a comparison of planted seed to harvested stand; expected yield; harvest stand efficiency; value per acre; stand count versus population; stand count versus hybrid; stand count versus fertilizer rate; stand count versus planting date; stand count versus downforce attributes.

In Example 5, the system of Example 4, wherein the at least one processor is further configured to generate one or more suggestions to an operator to improve future yields.

In Example 6, the system of Example 5, wherein the one or more suggestions include an ideal planting prescription.

In Example 7, the system of Example 1, further comprising an automatic swath control system in communication with the at least one processor configured to detect overlapping harvest areas and stop data recording during subsequent passes.

Example 8 relates to a method of estimating crop yield comprising sensing incoming plant stalks via one or more stalk sensors to generate stalk data, correcting stalk data, and displaying corrected stalk data to a user. Further in Example 7 correcting the stalk data by comparing as-planted data to stalk data geo-spatially and aligning as-planted data and stalk data on a row-by-row basis.

In Example 9, the method of Example 8, further comprising identifying if a guess row is being harvested and presenting a notification to a user of the guess row harvest.

In Example 10, the method of Example 9, further comprising generating guidance to correct errors from harvesting a guess row.

In Example 11, the method of Example 9, further comprising commanding an automatic steering system to guide a harvester to a corrected pass.

In Example 12, the method of Example 9, further comprising detecting an offset of plant stalks entering row units and comparing the offset of plants stalks across a swath of a harvester.

In Example 13, the method of Example 8, further comprising aligning the as-planted data and stalk data both laterally and longitudinally.

In Example 14, the method of Example 8, further comprising aligning the as-planted data and stalk data on-the-go.

Example 15 relates to a method for aligning agricultural data comprising identifying a center line of a harvester pass, identifying a swath width of a harvester, identifying a swath width of a planter, determining a number of harvester passes for each planter pass, determining an offset of the center line of the harvester pass for as-planted data from the planter, and aligning the as-planted data with as-harvested data.

In Example 16, the method of Example 15, wherein the as-planted data and as-harvested data are aligned on a row-by-row basis.

In Example 17, the method of Example 15, further comprising identifying a turning rate of the harvester and adjusting as-harvested data collection for the turning rate.

In Example 18, the method of Example 15, further comprising detecting an offset of plant stalks entering row units of the harvester; comparing the offset of plants stalks across a swath of the harvester; and identifying if a guess row is being harvested.

In Example 19, the method of Example 15, further comprising filtering as-planted and as-harvested data where the offset is greater than a threshold distance.

In Example 20, the method of Example 15, further comprising filtering as-planted and as-harvested data where the offset is greater than a threshold degree of heading difference.

While multiple embodiments are disclosed, still other embodiments of the disclosure will become apparent to those skilled in the art from the following detailed description, which shows and describes illustrative embodiments of the invention. As will be realized, the disclosure is capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a top view of a harvester, according to one implementation.

FIG. 2 is a schematic diagram of the system, according to one implementation.

FIG. 3 is a flow diagram showing operations of the system, according to one implementation.

FIG. 4A is a top view of a planter and a harvester showing row correlations between the planter and the harvester, according to one implementation.

FIG. 4B is a top, schematic view of a harvester head harvesting a guess row, according to one implementation.

FIG. 5 is a flow diagram of the system correcting data inputs, according to one implementation.

FIG. 6A is an exemplary implementation of a field map with multiple data overlays, according to one implementation.

FIG. 6B is an exemplary implementation of a field map with of FIG. 6A after data correction, according to one implementation.

FIG. 7 shows a display, according to one implementation.

### DETAILED DESCRIPTION

The various implementations disclosed or contemplated herein relate to various methods, devices, and systems for harvesting that are directed to the sensing of plants as they pass through a sensing system. Further implementations are related to data processing and visualization, including, in some applications, the adjustment of certain guidance and other harvest operations systems and/or features. The various implementations optionally include one or more sensing members mounted to a harvester row unit to engage with stalks as they enter the row unit. Further implementations may also include various associated computing components that are integrated into the system, such as processors, memory, displays, and communications components, as will be described further herein.

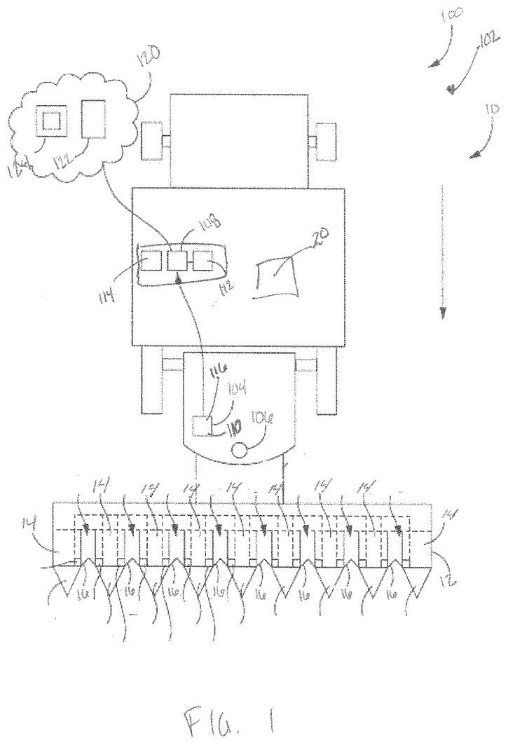

As has been previously described, such as in the various references incorporated herein, and shown in FIG. 1, sensing members 16 are used in conjunction with various processing components to measure harvest data such as stalk perimeter, stalk counts, missing and late emerged plants, and estimated and/or predicted yields, among other functions. In various implementations, the harvest data can be used provide information to the operator and allow for analysis, informed decision making, and/or automatic or manual adjustments to various harvester systems.

Further, in various implementations, the system includes a harvest data system 100 for visualizing and displaying data to an operator or other user, as well as for adjusting certain algorithms and other operations of the harvester 10. Certain implementations utilize row-by-row data to provide estimates and calculations of various parameters and/or outcomes, such as yield. Various implementations may also make use of harvest stand data. Certain features of the disclosed implementations relate to the display and use of such data. The harvest data system 100 may be implemented or used in conjunction with a variety of known harvesters and associated systems, as would be appreciated.

In various implementations, the harvest data system 100 comprises several components such as sensors, recording and processing components, and the necessary hardware, software and firmware components necessary for effectuating the various processes disclosed herein.

Certain of the disclosed implementations can be used in conjunction with any of the devices, systems or methods taught or otherwise disclosed in U.S. Pat. No. 10,684,305 issued Jun. 16, 2020, entitled “Apparatus, Systems and Methods for Cross Track Error Calculation From Active Sensors,” U.S. patent application Ser. No. 16/121,065, filed Sep. 4, 2018, entitled “Planter Down Pressure and Uplift Devices, Systems, and Associated Methods,” U.S. Pat. No. 10,743,460, issued Aug. 18, 2020, entitled “Controlled Air Pulse Metering apparatus for an Agricultural Planter and Related Systems and Methods,” U.S. patent application Ser. No. 16/272,590, filed Feb. 11, 2019, entitled “Seed Spacing Device for an Agricultural Planter and Related Systems and Methods,” U.S. patent application Ser. No. 16/142,522, filed Sep. 26, 2018, entitled “Planter Downforce and Uplift Monitoring and Control Feedback Devices, Systems and Associated Methods,” U.S. Pat. No. 11,064,653, issued Jul. 20, 2021, entitled “Agricultural Systems Having Stalk Sensors and/or Data Visualization Systems and Related Devices and Methods,” U.S. patent application Ser. No. 16/800,469, filed Feb. 25, 2020, entitled “Vision Based Stalk Sensors and Associated Systems and Methods,” U.S. patent application Ser. No. 17/013,037, filed Sep. 4, 2020, entitled “Apparatus, Systems and Methods for Stalk Sensing,” U.S. patent application Ser. No. 17/226,002 filed Apr. 8, 2021 and entitled “Apparatus, Systems and Methods for Stalk Sensing,” U.S. Pat. No. 10,813,281, issued Oct. 27, 2020, entitled “Apparatus, Systems, and Methods for Applying Fluid,” U.S. patent application Ser. No. 16/371,815, filed Apr. 1, 2019, entitled “Devices, Systems, and Methods for Seed Trench Protection,” U.S. patent application Ser. No. 16/523,343, filed Jul. 26, 2019, entitled “Closing Wheel Downforce Adjustment Devices, Systems, and Methods,” U.S. patent application Ser. No. 16/670,692, filed Oct. 31, 2019, entitled “Soil Sensing Control Devices, Systems, and Associated Methods,” U.S. patent application Ser. No. 16/684,877, filed Nov. 11, 2019, entitled “On-The-Go Organic Matter Sensor and Associated Systems and Methods,” U.S. patent application Ser. No. 16/752,989, filed Jan. 27, 2020, entitled “Dual Seed Meter and Related Systems and Methods,” U.S. patent application Ser. No. 16/891,812, filed Jun. 3, 2020, entitled “Apparatus, Systems and Methods for Row Cleaner Depth Adjustment On-The-Go,” U.S. patent application Ser. No. 16/918,300, filed Jul. 1, 2020, entitled “Apparatus, Systems, and Methods for Eliminating Cross-Track Error,” U.S. patent application Ser. No. 16/921,828, filed Jul. 6, 2020, entitled “Apparatus, Systems and Methods for Automatic Steering Guidance and Visualization of Guidance Paths,” U.S. patent application Ser. No. 16/939,785, filed Jul. 27, 2020, entitled “Apparatus, Systems and Methods for Automated Navigation of Agricultural Equipment,” U.S. patent application Ser. No. 16/997,361, filed Aug. 19, 2020, entitled “Apparatus, Systems and Methods for Steerable Toolbars,” U.S. patent application Ser. No. 16/997,040, filed Aug. 19, 2020, entitled “Adjustable Seed Meter and Related Systems and Methods,” U.S. patent application Ser. No. 17/011,737, filed Sep. 3, 2020, entitled “Planter Row Unit and Associated Systems and Methods,” U.S. patent application Ser. No. 17/060,844, filed Oct. 1, 2020, entitled “Agricultural Vacuum and Electrical Generator Devices, Systems, and Methods,” U.S. patent application Ser. No. 17/105,437, filed Nov. 25, 2020, entitled “Devices, Systems and Methods For Seed Trench Monitoring and Closing,” U.S. patent application Ser. No. 17/127,812, filed Dec. 18, 2020, entitled “Seed Meter Controller and Associated Devices, Systems and Methods,” U.S. patent application Ser. No. 17/132,152, filed Dec. 23, 2020, entitled “Use of Aerial Imagery For Vehicle Path Guidance and Associated Devices, Systems, and Methods,” U.S. patent application Ser. No. 17/164,213, filed Feb. 1, 2021, entitled “Row Unit Arm Sensor and Associated Systems and Methods,” U.S. patent application Ser. No. 17/170,752, filed Feb. 8, 2021, entitled “Planter Obstruction Monitoring and Associated Devices and Methods,” U.S. patent application Ser. No. 17/225,586, filed Apr. 8, 2021, entitled “Devices, Systems, and Methods for Corn Headers,” U.S. patent application Ser. No. 17/225,740, filed Apr. 8, 2021, entitled “Devices, Systems, and Methods for Sensing the Cross Sectional Area of Stalks,” U.S. patent application Ser. No. 17/323,649, filed May 18, 2021, entitled “Assisted Steering Apparatus and Associated Systems and Methods,” U.S. patent application Ser. No. 17/369,876, filed Jul. 7, 2021, entitled “Apparatus, Systems, and Methods for Grain Cart-Grain Truck Alignment and Control Using GNSS and/or Distance Sensors,” U.S. patent application Ser. No. 17/381,900, filed Jul. 21, 2021, entitled “Visual Boundary Segmentations and Obstacle Mapping for Agricultural Vehicles,” U.S. patent application Ser. No. 17/461,839, filed Aug. 30, 2021, entitled “Automated Agricultural Implement Orientation Adjustment System And Related Devices And Methods,” U.S. patent application Ser. No. 17/468,535, filed Sep. 7, 2021, entitled “Apparatus, Systems and Methods for Row-by-Row Control of a Harvester,” U.S. patent application Ser. No. 17/526,947, filed Nov. 15, 2021, entitled “Agricultural High Speed Row Unit,” U.S. patent application Ser. No. 17/576,463, filed Jan. 14, 2022, entitled “Apparatus, Systems, and Methods for Row Crop Headers,” U.S. patent application Ser. No. 17/724,120, filed Apr. 19, 2022, entitled “Automatic Steering Systems and Methods,” U.S. patent application Ser. No. 17/742,373, filed May 11, 2022, entitled “Calibration Adjustment for Automatic Steering Systems,” U.S. patent application Ser. No. 17/939,779, filed Sep. 7, 2022, entitled “Row-by-Row Estimation System and Related Devices and Methods,” U.S. Patent Application 63/299,724, filed Jan. 14, 2022, entitled “Agricultural Mapping,” U.S. Patent Application 63/315,850, filed Mar. 2, 2022, entitled “Cross Track Error Stalk Sensor,” U.S. Patent Application 63/351,602, filed Jun. 13, 2022, entitled “Apparatus, Systems and Methods for Image Plant Counting,” U.S. Patent Application 63/357,284, filed Jun. 30, 2022, entitled “Grain Cart Bin Level Sharing,” U.S. Patent Application 63/394,843, filed Aug. 3, 2022, entitled “Hydraulic Cylinder Position Control for Lifting and Lowering Towed Implements,” U.S. Patent Application 63/400,943, filed Aug. 25, 2022, entitled “Combine Yield Monitor,” U.S. Patent Application 63/406,151, filed Sep. 13, 2022, entitled “Hopper Lid with Magnet Retention and Related Systems and Methods,” and U.S. Patent Application 63/427,028, filed Nov. 21, 2022, entitled “Stalk Sensors and Associated Devices, Systems and Methods,” each of which is hereby incorporated by reference.

### A. Sense Stalks

Continuing with FIG. 1, the harvest data system 100 may be implemented on an agricultural vehicle 10 such as a harvester 10. Various harvester 10 configurations are known in the art, any of which may be used with the harvest data system 100 disclosed herein. In the implementation of FIG. 1, the harvester 10 includes a header 12 and the header 12 includes a plurality of row units 14. In various implementations, a harvester 10 is configured to harvest crops through the row units 14 disposed on the header 12, as would be readily appreciated. Once harvested by the row units 14 the crop flows towards the yield monitor 20, as would be recognized by those of skill in the art.

In certain implementations, the row units 14 can include one or more sensors 16. The sensors 16 can be stalk counting and/or measuring sensors 16 such as those disclosed in U.S. application Ser. No. 16/445,161, U.S. application Ser. No. 16/800,469, U.S. application Ser. No. 17/013,037, and U.S. application Ser. No. 17/226,002, each of which has been incorporated by reference herein.

During use the system 100, according to various implementations, can utilize any of the various sensing systems 16 and/or sensor assemblies 16 disclosed in the above incorporated references to obtain certain harvest data inputs, such as stalk count, stalk size, stalk circumference, stalk diameter, and the like as would be understood. In various implementations, the system 100 utilizes a rotational stalk sensor 16 constructed and arranged to measure the passage of each stalk and/or other stalk characteristics specific to the individual sensor type, as has been previously described in certain of the incorporated references. In any event, these sensor assemblies 16 mechanically engage or otherwise interact with passing plant stalks to detect and measure plant stalks on an individual plant and row-by-row basis, generating one or more harvest data inputs such as stalk count data and/or stalk size data.

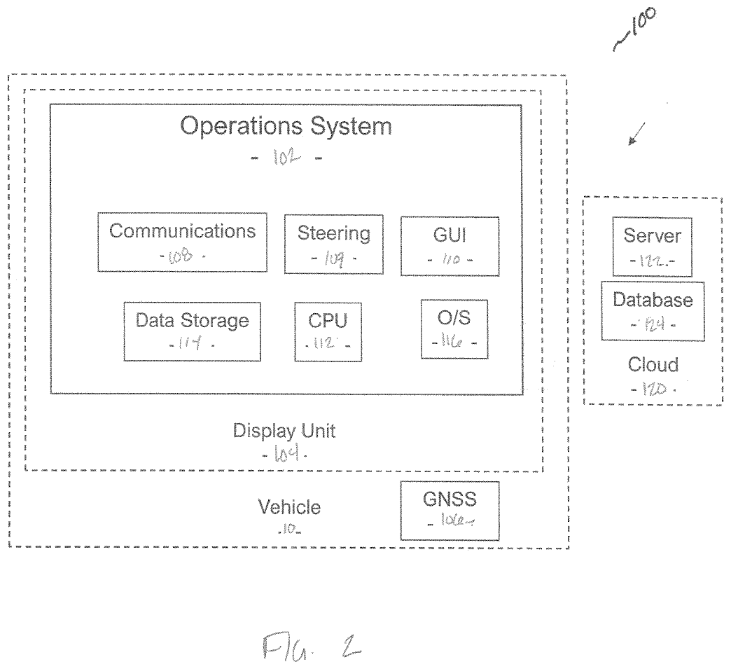

As shown in FIGS. 1 and 2, the harvest data system 100 according to various implementations has an operations system 102 that is operationally integrated with the sensors 16 and several other optional components on the combine/harvester 10 or elsewhere, such as a display 104. Various displays 104 are known to those of skill in the art, including in-cab displays 104, such as an InCommand® display from Ag Leader®. In various alternative implementations the display 104 is remote from the harvester 10 or other implement. It is appreciated that certain of these displays 104 feature touchscreens, while others are equipped with necessary components for interaction with the various prompts and adjustments discussed herein, such as via a keyboard, buttons, or other interface.

In various implementations, the system 100 is also operationally integrated with a GNSS or GPS unit 106, such as a GPS 7500, such that the system 100 is configured to input positional data for use in defining boundaries, locating the combine 10 for yield prediction, plotting guidance, and other purposes, as would be readily appreciated from the present disclosure and as discussed in the incorporated references.

Continuing with FIGS. 1 and 2, in various implementations, the operations system 102 is optionally in operational communication with a communications component 108. In certain implementations, the communications component 108 is configured for the sending and receiving of data for storage and processing, such as to the cloud 120, a remote server 122, database 124, and/or other cloud computing components readily understood in the art. Various implementations may also include storage on a remote drive/removable media such as a USB flash drive, CD-ROM, external hard drive, and the like. Such connections by the communications component 108 can be made via wired connections and/or wirelessly via understood internet and/or cellular technologies such as Bluetooth, Wi-Fi, LTE, 3G, 4G, or 5G connections and the like. It is understood that in certain implementations, the communications component 108 and/or cloud 120 component comprise encryption or other data privacy components, such as hardware, software, and/or firmware security aspects, as would be understood.

As shown in FIGS. 1 and 2, the operations system 102, according to certain implementations, has one or more optional processing and computing components, such as a CPU or processor 112, data storage 114, operating system (“O/S”) 116, and other computing components necessary for implementing the various technologies disclosed herein. It is appreciated that the various optional operations system 102 components are in operational communication with one another via wired or wireless connections and are configured to perform the processes and execute the commands described herein. As would be understood, each of these components can be located optionally at various locations around the vehicle 10 or elsewhere, such as in the cloud 120 and accessible by a wireless or cellular connection.

In various implementations, this connectivity means that an operator, enterprise manager, and/or other party is able to receive notifications such as adjustment prompts and confirmation screens on a mobile device or via another access point, such as a desktop, tablet, or secondary display. In certain implementations, these individuals can review the various data generated by the system 100 and make adjustments, comments, and/or observations in real-time, near real-time, or at subsequent times, as would be readily appreciated.

In certain implementations, the operations system 102 also includes or is operationally integrated with a steering component 109, such as an automatic or assisted steering component 109, such as SteerCommand® from Ag Leader®.

In certain of these implementations, the operations system 102 is housed in the display 104, and is operable by the user via, optionally, a graphical user interface (“GUI”) 110, though the various components described herein can be housed elsewhere, as would be readily appreciated. For example, the system 100 may utilize the cloud 120 and one or more cloud-based servers 122 and/or databases 124, as would be appreciated.

It is further understood that the various components shown in FIGS. 1 and 2 are optional and can be present or omitted in the various claimed implementations, and that certain additional components may be required to effectuate the various processes and systems described herein.

Further, while various implementations of the disclosed harvest data system 100 are disclosed herein it would be understood by those of skill in the art that the disclosed harvest data system 100 consists of one or more steps and/or components each of which is optional and may be omitted entirely. Further, the various steps may be performed in any order or not at all, and the order of presentation of various steps and sub-steps does not imply that they may only be performed in any certain order.

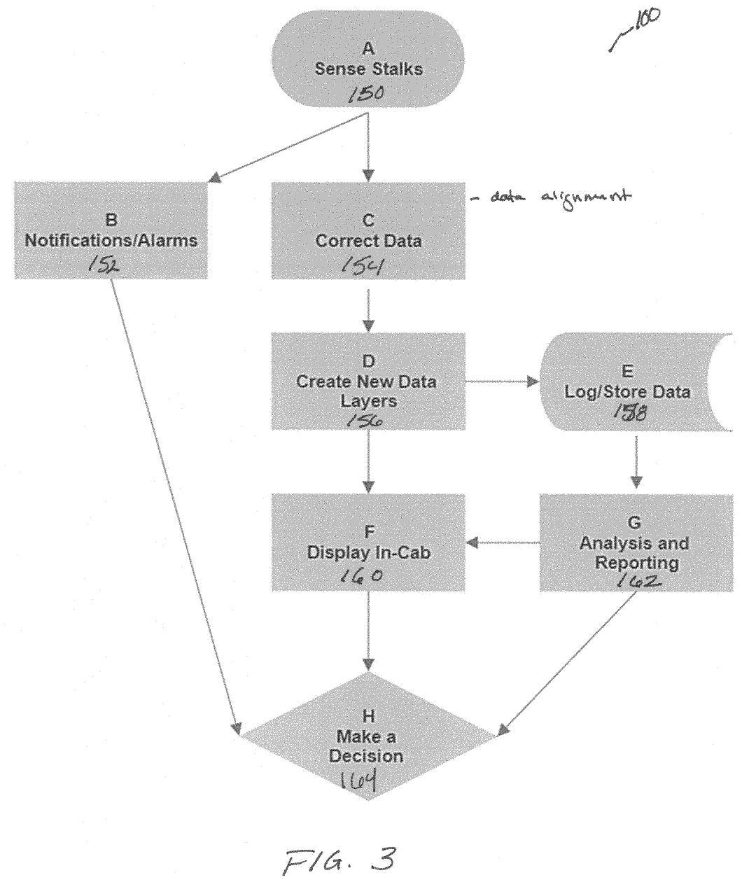

Turning now to FIG. 3, the system 100 includes number steps and sub-steps each of which is optional. In a first optional step, the system 100 senses stalks (box 150) as they pass through the sensors 16, discussed above. In a further optional step, the system 100 is configured to present notifications and/or alarms to a user (box 152) based on various operational parameters, as will be discussed further below. In another optional step, the system 100 is configured to correct the stalk data (box 154), according to one or more of the processes described in further detail herein.

In certain implementations, the system 100 is further configured to create new data layers (box 156) in an optional step. In a still further optional step, the system 100 logs/stores data (box 158) for simultaneous or future use and access. In another optional step, the various data, including, but not limited to, stalk data, corrected data, and new data layers, is displayed (box 160) to a user, for example on an in-cab display or other access point such as a mobile application or desktop program. In another optional step, the various data inputs can be analyzed and reported (box 162), as will be discussed further below. In a further optional step, the system 100 may be configured to make decisions (box 164), provide recommendations, and/or take action(s) based on the inputs, analysis, and reporting. These decisions/actions (box 164) may be manual and/or automatic.

### B. Notifications and Alarms

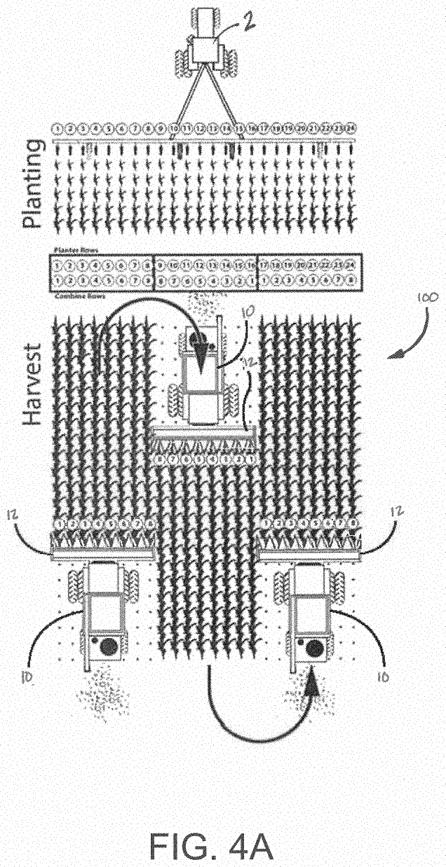

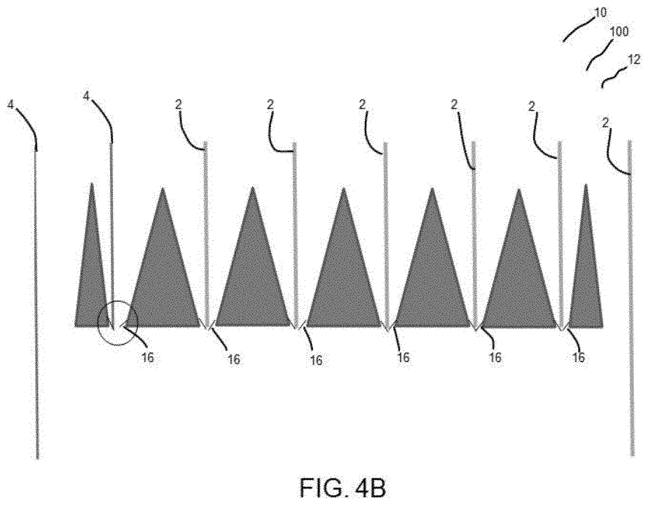

In various implementations, the system 100 includes an optional guess row warning system. As would be appreciated, the number of rows on a harvester 10 is typically an even multiple of the number of rows on a planter 2, as shown for example in FIG. 4A. For example, a planter 2 may have sixteen rows, so the harvester 10 may be eight or four rows. In another example, the planter 2 has twenty-four rows, so the harvester 10 has twelve, eight, six, or four rows. In these implementations, the corn head 12 is capable of always operating fully within one planter 2 pass.

Harvesting of a guess row may occur when the harvester is harvesting row from two different planter passes at one time. A guess row may occur in many different circumstances that would be understood by one of skill in the art. For example, in implementations where the harvester 10 is not an even multiple of the planter 2 during harvest, occasionally, one or more rows will be on a different pass and as such the row spacing may be different between those rows that are part of different planter 2 passes. A guess row may also occur when an operator begins harvesting what they believe to be are rows from a single planter pass but are incorrect.

FIG. 4B provides a schematic view of a harvester 10 harvesting a guess row 4. In this example, a six-row head 12 is harvesting five rows 2 from one planter pass and one guess row 4 from a different planter pass. As would be appreciated, and as shown in FIG. 4B, these guess rows 4 may be off-center on the corn head 12 due to the uneven spacing between planter passes. For example, the rows within a planter pass may be 30 inches apart but the space between successive planter passes may be 34 inches.

As would be appreciated, off-center harvesting may cause lost yields and other reductions in productivity. That is, harvesting a guess row 4 that is off-set from the proper row 2 may cause shelling of ears and in certain cases tipping stalks toward the ground such that the ears are not harvested. Loss of productivity can occur, for example, while harvesting a guess row 4, a proper row 2 from the planter pass is not being harvested and as such must later be harvested individually, this will take extra time and may cause excess grain loss from the harvester because harvesters are typically not configured for the low flow of crop resulting from a header only harvesting one or two rows, as would be understood.

In various implementations, the alarm or other notification may alert a user that they are not on the correct pass, they are off from being within a single pass, or are otherwise harvesting a guess row. In some implementations, the system 100 may provide guidance to a user on the direction and amount of movement necessary to correct the error. In certain implementations, the system 100 may automatically drive or adjust the position of the harvester 10 to be within a single pass—not harvesting a guess row.

In some implementations, the system 100 can detect situations where the stalks 2 are offset and therefore entering the head 12/row units 14 off center, as would be understood. The system 100, according to certain implementations, can compare the angle/approach/offset of stalks entering each row across the swath of the header 12. From this, the system 100 may be configured to determine if one or more rows is different or offset from the center more than the other rows, which indicates a guess row is being harvested. Continuing with the example of FIG. 4B the system 100 can detect the guess row 4 because the sensors 16 can indicate a cross track error for the guess row 4 compared to the majority of the rows 2 being harvested. When this happens, the system 100 may trigger an alarm. In various implementations, the alarm may be an audio and/or visual alarm, or other alarm type as would be recognized.

In various implementations, if a guess row 4 is being harvested, the system 100 alerts an operator of the guess row 4, as described above, such that corrective action can be taken. For example, after being alerted that a guess row is being harvested an operator may stop harvesting, move to the beginning of the row and reposition the harvester such that the rows being harvested are all from the same planter pass. In certain implementations, this correction is manual, while in alternative implementations this correction may be automatic, semi-automatic or done autonomously. In certain implementations, the system 100 commands an automatic steering system for correcting the harvesting of a guess row 4.

### C. Corrected Data Inputs

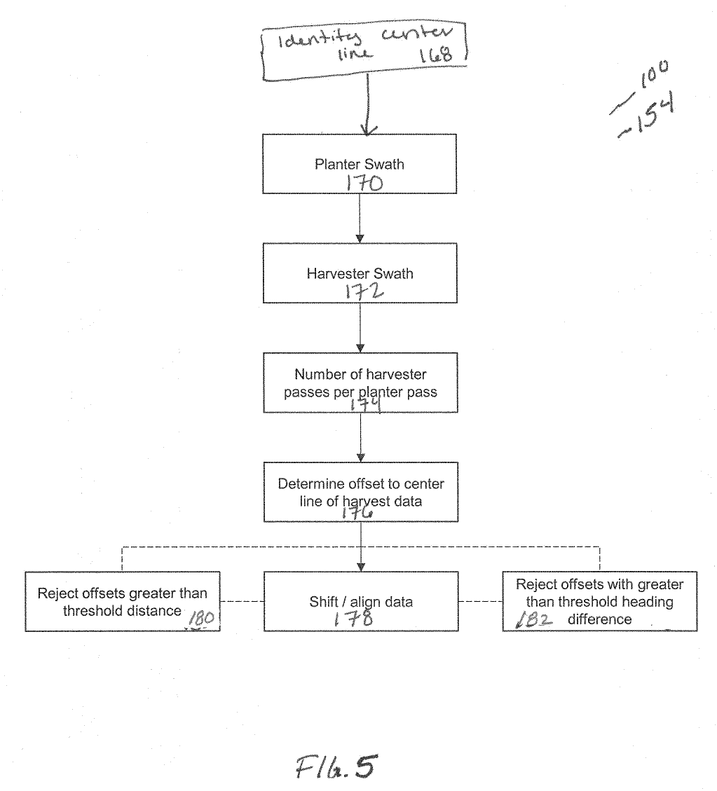

Turning to certain of the optional steps shown in FIGS. 3 and 5 in more detail, in various implementations, the system 100 is configured to correct data inputs (box 154). In certain implementations, data correction (box 154) may include comparing the harvested pass to the planted pass geo-spatially. That is, the harvest data can be aligned on a row-by-row basis, and in some implementations on a plant-by-plant basis, with as-planted, as-treated, or other information, as would be appreciated. As would be further appreciated, data gathered during harvest, planting, or at other times may have errors due to GPS inaccuracy and/or GPS drift that can affect the alignment of data across time. The ability to align data from different points in time for comparison and analysis is necessary to obtain valuable information and further data for further processing and analysis.

In certain of these implementations, alignment of data may be done manually or automatically. The system 100 may automatically shift the harvested data (yield, stand count, stalk size, stalk count, etc.) to overlay with the as-planted information including locations, treatment, seed types, and other data as would be appreciated. In certain implementations, a user may be promoted to accept, reject, or further adjust an automatic shift/alignment of the data.

In various implementations, the data is aligned when the number of row units on the planter is a multiple of the number of row units 14 on the harvester 10. For example, a 12-row planter may be aligned with a 6- or 12-row harvester header 12, or a 24-row planter may be aligned with a 4-, 6-, 8-, or 12-row harvester header 12, as would be understood.

As would be understood, many agricultural implements include numbered row units, typically numbered from left to right. The number of row units on a particular implement is generally a known value as are the positions of each row unit with respect to a GPS receiver. In these and other implementations, the GPS offset for each row unit is known.

In further implementations, and shown for example in FIG. 5, the system 100 executes a series of optional steps to align the as-planted and harvest data. In an optional step, the system 100 identifies the center line of an as-planted pass (box 168) or pass of another data set. In various implementations, the center line of an as-planted pass (box 168) is the midway point along the swath of the planter.

In another optional step, the system 100 identifies the swath width of the planter (box 170) and the harvester (box 172), such as via a user input, stored data, and/or system configuration. As would be appreciated, the swath width correlates to the number of row units on each implement such that the number of harvester passes per planter pass can be determined (box 174). For example, there would be three harvester passes per planter pass in an implementation utilizing a twenty-four-row planter and an eight-row harvester.

The number of harvester passes per planter pass (box 174) may then be used in a further optional step to determine the offset where the center line of the harvest data should be when compared to the as-planted data. That is, in one specific example where the harvester has half the swath of the planter, two center lines are needed for harvester data for each planter pass. Then the harvest data can be shifted or adjusted (box 178) as needed to match the as-planted data for alignment.

In another optional step, the system 100 may be configured to filter out data or not shift data where the indicated offset is greater than a threshold distance (box 180). For example, the threshold (box 180) may generally be less than half the harvester swath, for example 7 ft on a 15 ft wide corn head (box 180). An offset larger than the threshold may be indicative of bad data or inaccurate data and as such the alignment would result in inaccurate outputs. In another optional step, the system 100 may, optionally, prompt a user to either accept or deny the alignment to ensure accuracy.

In another optional step, the system 100 may be configured to filter out data where the offset indicated a greater than a threshold degree heading difference (box 182). For example, a 20-degree heading difference may be the threshold. Such a large offset in degree of heading difference may be indicative of an error in the as-planted or harvest data. For example, the orientation of passes allows the harvester pass and planter pass to go in opposite directions (0 to 180 degrees) and have 20 degrees of flexibility. That is, in one example, in a pass where the planter planted the crops heading south, the harvester may harvest the pass heading both north and south with an up to 20 degrees of flexibility to account for variability in GPS positioning and other factors, as would be understood.

It would be appreciated that the threshold degree of heading difference, discussed above, may be any desired or inputted value. In certain implementations, the threshold degree of heading difference is a user entered value. In various alternative implementations, the threshold degree of heading difference may be pre-programmed or otherwise determined by the system 100. In certain implementations, the system 100 may utilized artificial intelligence, machine learning, and/or other algorithmic approach to determine, modify, and/or refine the threshold over time.

An opposite type of shift is also possible, where the as-planted data is shifted to be aligned with the harvest data. Many of the same optional steps may be used for these implementations, with adjustments made to the processing to shift the planter data instead of the harvest data, as would be appreciated.

In a further implementation, the data may be aligned on a plant-by-plant basis, thereby aligning both rows and plants within the field. That is, the data may be aligned both laterally (left/right) and longitudinally (forward/backward).

In various implementations, alignment of data (box 178) may be applied to cataloged and mapped data and saved as a new map or saved over an old map. In alternative implementations, the alignment (box 178) may be temporary for a specific analysis and may revert once the operation/analysis is complete.

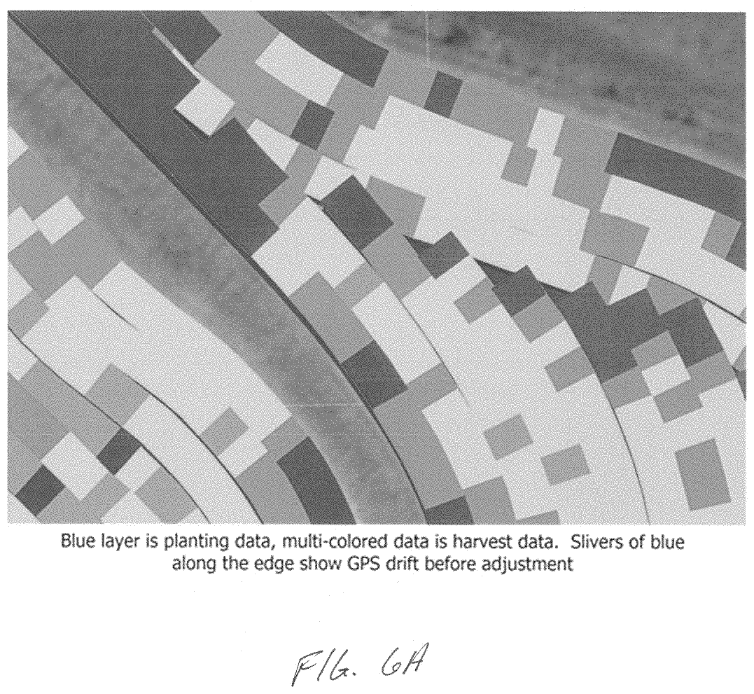

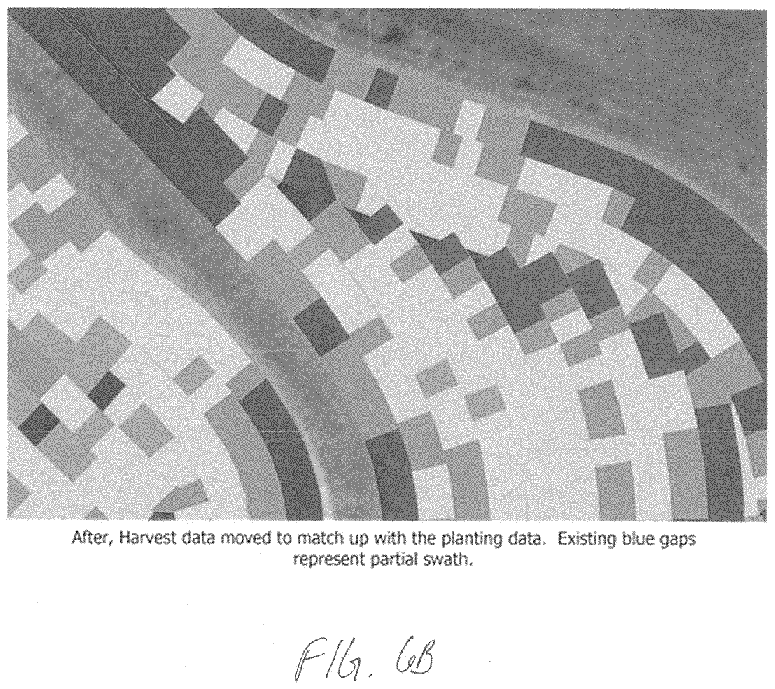

FIGS. 6A and 6B show an exemplary implementation of the correction of data by alignment. In FIGS. 6A and 6B the blue data layer (the first layer), below the harvest data, is as-planted data, and the red/orange/yellow/green layer (a second layer) is as-harvested data. As can be seen in FIG. 6A the as-planted and as-harvested data do not align—areas of the data not overlapping—indicative of GPS inaccuracy and/or GPS drift. Using the various optional steps discussed above the data can be aligned, as shown in FIG. 6B.

In an alternative implementation, at the start of each harvester pass the system 100 may automatically, or a user may manually, flag the full swath of the harvester and incrementally count each row from the field edge. That is, for example, with a 12-row planter and 12-row harvester both would start row number 37 on the 4th pass from the edge of the field, and they would do the same with the planter data and use the incrementing row numbers across the field for comparison. Various alternative start points for counting rows are possible, would be understood by those of skill in the art, and are contemplated herein.

In a further optional implementation, all planter passes could be pre-loaded in the display 104 at harvest and as the operator starts in the field. In these and other implementations, instead of the live GPS point being used to log data, the system 100 may use the GPS point of the nearest planter pass (or sub-pass) of the planting data to align the harvest data.

In a still further optional implementation, the system 100 may include a second GPS antenna/receiver on the planter that is utilized to log coverage paths. The GPS data of logged paths may then be used for determining the offset rather than the swath of the original planter data.

In alternative implementations, the system 100 may not execute alignment steps and instead assume that the full swath of the planter and the full swath of the combine are in the same location.

As noted previously, the steps of data alignment may be performed locally, such as on a display, or remotely, such as via the cloud. A user may align or interact with aligned data via an online system, mobile, device, local desktop program, or the like as would be understood. In certain implementations, data alignment may occur in real-time or near real-time on-the-go during harvest or other treatment. In certain alternative implementation, data alignment may occur after harvest is complete or periodically during harvest.

In certain implementations, the system 100 uses the known or sensed spacing of the stalks and the heading of the planter to determine the heading of the data. Data may be excluded from the set that does not correspond to the direction of the row. This exclusion may allow for the exclusion of weeds and volunteer corn that may otherwise be counted as productive corn plants by the sensors 16. The exclusion of data based on known spacing may also eliminate errant data when multiple planter rows converge in non-square parts of fields.

When harvesting at an angle different from the heading angle of the planted row on purpose (i.e., entering the field and determining this from planting data), the system 100 may detect this condition and understand that stalks would be entering the row units 14 and sensors 16 at different angles via an algorithm, program, or other setting. That is, the system 100 is configured to sense and detect if the incoming stalk data is in the correct direction based on the harvester heading and the known as-planted information. When the incoming stalk data is not in the correct direction that data may be excluded from the data set, or otherwise noted in the data set as being an outlier. In various implementations where an anomaly in heading angle, or other data is detecting, a user may be prompted to review and accept, deny, or otherwise mark data containing the anomaly.

In certain of these implementations, automatic stalk counting may function as normal, but when harvesting an already harvested area that the stalk counting data can still be collected and “over-write” the previous data collected at an angle. In certain implementations, the system 100 may interface with or otherwise include an automatic swath control system, as would be understood. In these and other implementations, for example, when the edge of a field has already been harvested and a subsequent path overlaps this already harvested area the system 100 can stop logging in these overlap areas.

In various implementations, the system 100 can determine when multiple pieces of data correspond to the same geographical location. This condition may occur when a portion of the corn head passes over an area that has already been harvested. The system 100 may be configured to detect when such a second or overlapping pass is occurring and exclude that data in favor of the data from the actual harvest of the row. Alternatively, the system 100 may prompt a user of a potentially overlapping area or of a detected overlapping area such that a user may accept or reject the data in the overlapping area.

In certain implementations, the system 100 can detect a narrow diameter stalk and optionally remove it from the count of viable ear producing plants, as has been previously described. As is generally appreciated by those of skill in the art, late emerged or otherwise undersized stalks that typically do not produce an ear and as such can be excluded from the productive stalk count. In various implementations, narrow diameter stalks/non-producing plants are included in the stalk count but are otherwise noted as such or are included in a separate count for analysis purposes, as would be appreciated.

### 1. Start/Stop Delay

In various implementations, the system 100 may be configured to implement a start/stop delay. In certain implementations, the start/stop delay may be used when the harvester 10 is transitioning in and out of stalks. As would be appreciated, when beginning a harvest pass there is a time delay from when the stalks enter the corn head and when the data is logged by the system 100. The system 100 may adjust the map from the time the header enters the crop until the harvested crop is detected by the sensors and yield monitor.

In certain implementations, that start/stop delay filters out data when the harvester is turning around after finishing a pass and before beginning the next pass. In further implementations, the system 100 includes a flow shift offset that considers the delay between when stalks are detected by the sensors and when the crop flows past the yield monitor. These delays may vary from about 1 second to about 15 seconds. In certain implementations, the start/stop delay is about 4 seconds, and the flow shift offset is about 12 seconds. These delays are known values and may be known by the system 100 or user entered. In some implementations, the start/stop delay may vary by user, as operators may have differences in how they operate the harvester and how fast they drive in and out of passes, and when they raise/lower the head, triggering the delay time. In certain implementations, the system 100 may include personalized profiles or preset settings for different users, such as one, two, or more settings for those users most frequently operating the harvester.

By accounting for the delays in harvesting including time to turn around and raise/lower a head, as well as the inherent time it takes crop to flow through the harvester the maps generated may be more accurate. If these delays are not accounted for the data and its geo-referencing may be skewed and appear that crop is being harvested in areas where it is not. These delays may also be used to adjust/align the data longitudinally (forward/backward) as discussed above.

### 2. Turning Rate

In still further implementations, the system 100 may be configured to use the heading and turning rate of the harvester 10 to adjust the processing of data from the sensors 16. For example, as the harvester 10 traverses a curve the spacing and/or population of crops may vary from the straight portion of a row. The system 100 may adjust its calculations and/or predictions using the heading and turning rate of both the harvester 10 and the planter.

In further implementations, the system 100 may be configured to automatically adjust a stalk counting algorithm based on field and crop conditions, as would be appreciated. In certain implementations, the analysis algorithms and processes may be adjusted for field and crop conditions.

### 3. Offset Detection and Adjustment

In a further implementation, the system 100 is configured to detect when the harvester 10 is offset from the row. For example, due to poor driving, GPS drift, or other steering error the harvester 10 may be laterally offset from the row, such that the row units 14 and row crops are no longer in line. This offset harvesting can cause lost yield, as would be appreciated. In certain implementations the sensors 16 will miscount stalks because of an offset and as such the system 100 may adjust the counts to account for this error. In certain implementations, the system 100 may apply a multiplier to the actual sensed count to correct an offset error.

In an optional step, the system 100 may include a calibration routine to calibrate for an offset. In a further optional step, the system 100 may apply an offset or multiplier to the sensed stalk count to account for or adjust for downed corn, that is corn that is poorly standing and therefore more difficult to effectively harvest. In various harvest situations involving downed corn, the crops may be bunched together or the sensor 16 may become plugged, as the plants typically do not feed evenly into the row units 14. The sensors 16 can detect this bunching and/or a plugged row unit, as has previously been described. In these implementations, the system 100 can apply an adjustment factor when these conditions are present. Further, in certain implementations, when a row is plugged, the system 100 may emit a visual and/or auditory warning to an operator that the row is plugged.

### 4. Header Height Sensing

In a further implementation, the system 100 uses stalk size information from the sensors 16 for header height sensing and control systems. As would be understood the size/circumference/diameter of a corn plant varies from the top to the bottom becoming thicker/larger towards the base/ground, and thinner/smaller at the top. The system 100 may be configured to detect when a header 12 is too high or too low based on the detected stalk size. In certain implementations, the system 100 may adjust the counting algorithm based on the height of the header 12. Using the detected header height, the system 100 may be able to better detect stalks and missing stalks. Further, the detected header 12 height may allow for increased accuracy in detected stalk sizes and spacing.

### 5. Ground/Head Speed

In still further implementations, the counting algorithm may be adjusted based on the ground speed of the harvester 10 relative to the operational speed of the corn header 12. As would be understood, corn headers 12 typically run at a set speed, but the harvester 10 may increase or decrease ground speed throughout harvesting operations. Stalks will feed through row units 14 and sensors 16 differently at different ground speeds. The ground speed of the harvester 10 and the speed of the header 12 can optionally be inputs in setting and adjusting the stalk detection, counting, and/or measuring algorithms.

In various implementations, the counting algorithm may be adjusted based on header speed. If the header is operating at below optimal speed a build-up of stalks may occur. This build-up may be detected by the system 100 such that the header may automatically speed up and/or a warning may be put to an operator who may then manually increase the speed of the header. Alternatively, the ground speed of the harvester may be slowed such that the stalks are no longer entering the corn head at a pace faster than the corn head can accommodate. The opposite situation is also possible wherein the header speed is too fast, and the header can be either slowed or the ground speed increased.

### D. Create New Data Layers

The various adjustments and alignments discussed above may account for GPS differences in the various operations and allow direct comparison between the data from when that row was planted (as-planted data, i.e., plant population, singulation, downforce, and the like) and when that same row was harvested (as-harvested data, i.e., harvest stand, moisture, ear count, yield, and the like). Various other data may also be aligned with harvest data, for example strip tillage data reflecting where fertilizer was applied, insecticide treatment data such as from a sprayer, locations and heights of raised tillage beds (berms) for flood irrigation, for example berm height differences may result in poor stand after flooding, and other data as would be appreciated.

The alignment of data may result in any number of outputs including numerical reports, charts, visual maps, combinations thereof, and the like. The various outputs may allow a stakeholder to assess mechanical issues, application consistency, or other implement parameters, as would be understood in light of this disclosure. Further, this aligned data and various outputs may allow for assessment of the impact of wheel placements, that may cause soil compaction, and the effect of that compaction on yields.

After data has been aligned from a previous pass to the harvest pass, the user can create other data or map layers to assess the relationship between the various data layers. In one example, the system 100 may create a data layer comparing the planted seed population to the harvested stand of what grew. This layer provides a user with the ability to gauge the number of plants that did not emerge or did no emerge at the same time resulting in small stalks, as mentioned above.

As would be recognized by those of skill in the art, seed is typically sold with a rated gemination percentage. In crops, such as corn, the rated germination percentage is often 95%, meaning that if 100 seeds were planted 95 or more should emerge and be viable plants. By comparing the planted seed population with the harvested stand count a user can assess if the rated germination percentage is being met. If the difference in the two layers is around 95% then a user would know they are within the expectations of the seed company, and most likely the planter was set properly. If the difference in the two layers is lower than 95%, for example 92-93%, further analysis may be conducted to find the cause of the lost yield. For example, the seed may not have been stored properly, or the planter machine settings may have been improperly adjusted.

As would be understood by those of skill in the art, the “rule of 7” is a metric that is used to estimate the proper plant population. For crops such as corn, if the growing season is average, including the amount of rainfall, the general rule is a user would expect to get 7 bushels of grain per 1,000 seeds planted. So, if 30,000 seeds were planted per acre, about 210 bushels/acre would be harvested. Because the system is able to measure the plant stand, as well as create the yield layer, the information for expected plant population and bushels/acre can be calculated. Further, as discussed herein, the system 100 can determine the harvest stand count, and the harvest stand efficiency can be calculated. In these and other implementations, the system can determine if there are hybrids that are less dependent on having a higher stand count to maximize yield. Continuing with the above example, a user may plant 30,000 seeds per acre and measure the stand at 27,000 plants per acre at harvest, and still achieve 210 bushels per acre. While in other areas of the field, the user may have planted more seeds per acre, and not seen any increase in yield, so the user can observe that this seed variety can be planted at lower populations and have a similar yield, increasing overall efficiency as less seed needs to be purchased and planted for the same yield. Knowing the efficiency of a variety can increase the profitability of a grower.

Still another metric is the value per acre that is lost due to an imperfect stand. Lost value per acre can be determined by taking the amount of seed planted and comparing that planted amount to the number of plants per acre that emerged to determine a percentage of plants lost. If the number of plants lost exceeds the rated germination percentage established by the user, seed supplier/manufacturer, or other entity, there is opportunity lost. The amount of plants missing compared to the expected germination is the opportunity loss of not having the best/expected stand. For example, a typical rated germination percentage may be 95%, so there is an expected about 5% loss. In this example, if the actual number of plants harvested/or emerged is less than 95%, there is a greater than 5% loss, and the difference is the opportunity lost.

The amount of seed planted but not emerged, multiplied by the number of bushels lost, and value of a bushel allows the user to assign an economic loss from having fewer seeds emerge than desired. This economic loss can then help justify changes/modifications to machinery or agronomics to improve overall yields/profit in subsequent plantings.

### E. Log/Store Data

In certain implementations, the data can be processed in the cloud 120 or other off-harvester 12 storage/processing location, as would be understood. In some implementations utilizing cloud 120 processing, a server 112 or database 114 can link the harvested row to the corresponding planted row or other row of as-planted or as-applied data. In some implementations, the matched rows are communicated back to the display 104 for visualization and/or interpretation by a user.

In various implementations, the system 100 is configured to store data in the memory 114 related to field trials, research plots, and the like. For example, the planted population, previous crop, fertilizer application, harvested population, and the like may be collected and stored by the system 100. In certain implementations, the system 100 may compare the as harvested data to similar data gathered during field trials. Users may then be able to directly compare the expected results with actual results over all treatments. Users may also be able to explore the impact, if any, of various treatments.

### F. Display In-Cab

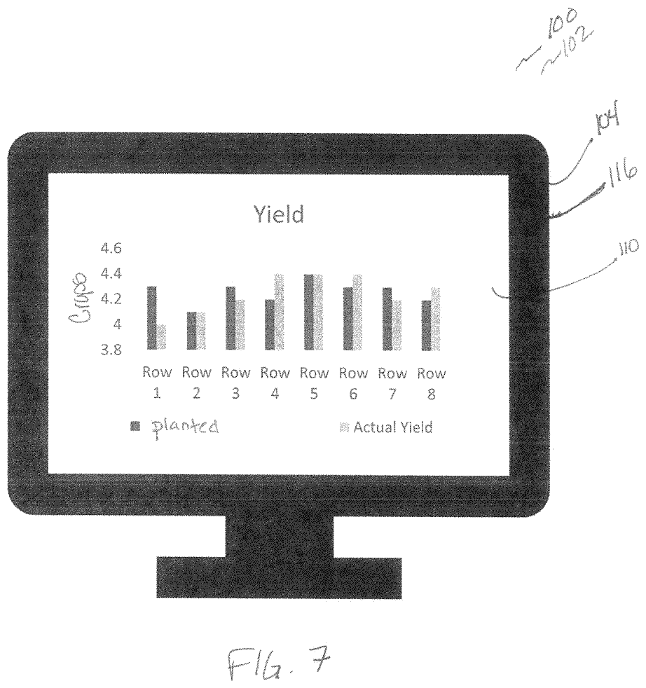

In certain implementations, the system 100 may be configured to display a comparison of excepted or as-planted yield with real-time or near real-time actual yields or stalk counts, as shown for example in FIG. 7. In these and other implementations, the display 104 is in communication with various components of the operations system 102 and configured to compile and display the data in a bar graph or other format for viewing by an operator. In alternative implementations, the display 104 may show the number of missing plants, optionally on a row-by-row basis.

In further implementations, the display 104 and/or operations system 102 can be configured to display to a user an on-screen field map comprising various pieces of relevant data. In certain implementations, the field map may include a color-coded map, such as that of FIGS. 6A and 6B, showing yield distributions across a field. Optionally, in some implementations, the field map may highlight or otherwise emphasize areas within a field where the harvest stand is below a threshold value. In various implementations, the threshold value for the harvest stand is user entered. In various alternative implementations, the threshold value for the harvest stand is set to a percentage of the as-planted stand and may be automatically adjusted as the as-planted stand changes across a field. For example, the threshold may be 95% such that all areas of the field in which the actually harvested stand is less than 95% of the as-planted stand are highlighted or otherwise emphasized for communication to an operator.

Continuing with FIG. 7, in various implementations, system 100 including the operations system 102, display 104, and other components are configured to display to a user a bar graph and/or other data visualization mechanism including, but not limited to, a map, data listing, line graph, chart, and the like. These data displays may be utilized by operators to identify trends and/or anomalies to the harvest stand. Various data points may include planting variety, treatment, soil type, machinery used, and the like.

In various implementations, the system 100 may be configured to display data that is averaged over a time period, for example the average number of stalks over the last 10 minutes, 2 hours, 5 acres, etc. In further implementations, data may be generated on a row-by-row, per field or field-by-field basis.

In certain implementations, an operator and/or the system 100 may expect to see lower harvest stand in certain areas of the field and therefore desire to isolate those areas. For example, the harvest stand count may be expected to be lower in areas where the planter had to turn around on end rows, or when there was a planting error that may or may not have been fixed in the field during planting. For these areas, an operator may desire to see an updated average harvest stand during harvest for just these areas or a count that excludes these areas.

In still further implementations, the system 100 can be configured to remove population stand data from the headlands. Including this population information can lead to inaccuracies in management decisions. This is because depending on how many passes were made during the season, the headlands may misrepresent the actual stand that would have been there if there were no applications made after the crop came up. Users may desire to exclude these areas would be necessary to provide an accurate representation of the as-planted rows. Further, these areas of the field may also have increased compaction, and therefore have a reduced stand that could impact planting comparisons. Said another way, a number of factors exist in the headlands that could have an effect on the harvest stand that are independent of the as-planted information and as such exclusion of these data points may be necessary for accurate comparisons to be made and conclusions drawn from the as-planted versus harvest stand data.

### G. Analysis and Reporting

In various further implementations, the system 100 is configured to show summary data and various reports on a display 104, such as for an event that was collected by a field display. For example, the system 100 can generate and display data related to: stand count versus population; stand count versus hybrid; stand count versus fertilizer rate; stand count versus planting date; stand count versus downforce attributes; and stand count versus other agronomic attributes, as would be appreciated.

In some implementations, harvest stand performance can be compared to various attributes for identification and analysis of certain anomalies that were recorded or created external to the display. Such comparisons may include, but are not limited to harvest stand verses row-by-row downforce; harvest stand based on soil moisture; harvest stand based on organic matter; harvest stand performance based on turn compensation; harvest stand based on as planted stand; harvest stand variance based on other applied data such as NH₃ knife, side dress, or the like; harvest stand based on drainage tile; harvest stand based on sprayer track; harvest stand issues from seed meter within row patterns; and harvest stand issues from different rows of a planter. Various other parameters/conditions that may be analyzed include topography, planting prescription, soil type, hybrid, manure history, population, crop rotations, planting date, weather, and the like, as would be appreciated.

In various implementations, the system 100 is configured to test and correlate the various parameters for maximum yield production and economic output. In certain implementations, the system 100, processors 112, and other components are configured to execute an algorithm to analyze the various harvest data, including the as-harvested plant stand to output prescriptions for future plantings to maximize yield and/or economic gains. In certain implementations, the algorithms may include or otherwise utilize contemporary machine learning, neural networks, and/or other artificial intelligence techniques.

In various of these implementations, the data points may allow a user to evaluate various factors contributing to a good stand or a poor stand. For example, if the harvester detects inconsistency the data may show which prior application/pass/row unit likely caused the inconsistency. Certain non-limiting examples of factors that may affect the harvest stand include compaction from previous operations, poor planting conditions, fertilizer injury, manure application, need for drainage tile, weather, such as drought or flooding, and the like as would be appreciated.

In certain of these implementations, a response curve is generated to show the actual yield harvested compared to the plant stand, and other related relationships. In these and other implementations, the response curve may provide a user with the ideal as-planted population to achieve the highest yield. That is, the highest planted population may not yield the highest yield. In certain implementations, the system 100 may generate a recommended or ideal planting prescription/seeding population that considers the expected yield, seed cost, commodity price, and other factors to achieve the best economic return. In certain of these implementations, the system 100 may be utilized not only by farmers and operators but also consultants and salespersons for making recommendations to farmers on how to maximize their profits.

In certain implementations, the system 100 performs an economic calculation of the assumed loss from harvested stand compared to the as-planted stand. In some implementations, the system 100 can determine the lost income potential in a case where there was a perfect stand compared to the planted or actual stand. In these and other implementations, the data may be reported numerically and/or visually, such as in a map, graph, or other visual representation. The difference between a perfect stand and the actual as-harvested stand represents the opportunity loss by not having a perfect crop.

In certain implementations the algorithm/calculation may be adjusted via various factors such as germination and yield efficiency. In an optional adjustment for seed emerged efficiency, where the industry claims 95% germination, as plant density increases, the yield efficiency will decrease, so expected yield may be buffered to 95% to account for the declination if there was a perfect stand.

As noted above, optional factors inputted into the system 100 may account for the cost of seed and the market price of grain. In various implementations, these values may be user adjustable. In alternative implementations, these values may be obtained automatically from various market reports, as would be understood. Various additional parameters and values used in the calculation can be obtained from in-field sensors, historical data, weather reports, and other databases as would be appreciated.

In various implementations, the system 100 is configured to detect the exact planter row unit that planted a missing plant. Overall, planter performance can be reported based on the total rows of the whole field rather than by planter row unit. Alternatively, planter performance may be evaluated row-by-row.

In another implementation, harvest stand performance is compared to wheel traffic from the planter operation (planter and tractor wheel tracks) as well as other options like tillage and grain cart tracks can be reported. In these and other implementations, the system 100 may utilize a GPS 106 or other navigation system to record and catalog tracks made by various machinery in agricultural operations, including planters, sprayers, harvesters and the like. These recorded paths can be correlated to areas with missing plants to determine if the tire paths had an effect on the stand.

### H. Make a Decision

In certain circumstances, as discussed briefly above, the system 100 is configured to provide a recommendation for action to be taken. For example, the system 100 may generate a planter report card and/or suggested enhancements (for example, downforce, high speed delivery, singulation) based on the various harvest data as compared to as-planted or other agricultural data discussed herein. The system 100 may provide reports and recommendations for actions to improve future yields. In various implementations, actions taken may be automatic or semiautomatic. For example, the system 100 may automatically program the planter to use a different amount of downforce in subsequent plantings as indicated.

Although the disclosure has been described with references to various embodiments, persons skilled in the art will recognized that changes may be made in form and detail without departing from the spirit and scope of this disclosure.

What is claimed is:

1. An agricultural data system comprising:
(a) at least one stalk sensor disposed on a harvester configured to sense incoming crop stalks;
(b) at least one processor in communication with the at least one stalk sensor; and
(c) a display in communication with the at least one processor,
wherein the processor is configured to align as-planted data with as-harvested data from the at least one stalk sensor.

2. The system of claim 1, further comprising at least one GNSS unit in communication with the at least one processor.

3. The system of claim 1, wherein the at least one processor is configured to detect when the harvester has harvested crop at an offset.

4. The system of claim 1, wherein the at least one processor is configured to map, chart, or report one or more of: a comparison of planted seed to harvested stand; expected yield; harvest stand efficiency; value per acre; stand count versus population; stand count versus hybrid;
stand count versus fertilizer rate; stand count versus planting date; stand count versus downforce attributes.

5. The system of claim 4, wherein the at least one processor is further configured to generate one or more suggestions to an operator for improving future yields.

6. The system of claim 5, wherein the one or more suggestions include an ideal planting prescription.

7. The system of claim 1, further comprising an automatic swath control system in communication with the at least one processor configured to detect overlapping harvest areas and stop data recording during subsequent passes.

8. A method of estimating crop yield comprising:
sensing incoming plant stalks via one or more stalk sensors to generate stalk data;
correcting stalk data comprising:
comparing as-planted data to stalk data geo-spatially; and
aligning as-planted data and stalk data on a row-by-row basis; and
displaying corrected stalk data to a user.

9. The method of claim 8, further comprising identifying if a guess row is being harvested and presenting a notification to a user of the guess row harvest.

10. The method of claim 9, further comprising generating guidance to correct errors from harvesting a guess row.

11. The method of claim 9, further comprising commanding an automatic steering system to guide a harvester to a corrected pass.

12. The method of claim 9, further comprising detecting an offset of plant stalks entering row units and comparing the offset of plants stalks across a swath of a harvester.

13. The method of claim 8, further comprising aligning the as-planted data and stalk data both laterally and longitudinally.

14. The method of claim 8, further comprising aligning the as-planted data and stalk data on-the-go.

15. A method for aligning agricultural data comprising:
identifying a center line of a harvester pass;
identifying a swath width of a harvester;
identifying a swath width of a planter;
determining a number of harvester passes for each planter pass;
determining an offset of the center line of the harvester pass for as-planted data from the planter; and
aligning the as-planted data with as-harvested data.

16. The method of claim 15, wherein the as-planted data and as-harvested data are aligned on a row-by-row basis.

17. The method of claim 15, further comprising identifying a turning rate of the harvester and adjusting as-harvested data collection for the turning rate.

18. The method of claim 15, further comprising detecting an offset of plant stalks entering row units of the harvester; comparing the offset of plants stalks across a swath of the harvester; and identifying if a guess row is being harvested.

19. The method of claim 15, further comprising filtering as-planted and as-harvested data where the offset is greater than a threshold distance.

20. The method of claim 15, further comprising filtering as-planted and as-harvested data where the offset is greater than a threshold degree of heading difference.
